(19) United States
(12) Patent Application Publication
(10) Pub. No.: US 2026/0313451 A1
(43) Pub. Date: Oct. 8, 2026

(54) HOSTING NETWORK ACCESS CONTROL AND CONGESTION HANDLING

(71) Applicant: InterDigital Patent Holdings, Inc., Wilmington, DE (US)

(72) Inventors: Anuj Sethi, Ottawa (CA); Guanzhou Wang, Brossard (CA)

(73) Assignee: InterDigital Patent Holdings, Inc., Wilmington, DE (US)

(21) Appl. No.: 18/998,292

(22) PCT Filed: Jul. 26, 2023
(86) PCT No.: PCT/US2023/028645

§ 371 Date: Jan. 24, 2025

Related U.S. Application Data
(60) Provisional application No. 63/392,473, filed on Jul. 26, 2022.

(51) Int. Cl. H04W 28/02; H04W 48/20; H04W 60/06

(52) U.S. Cl. CPC H04W 28/0289; H04W 48/20; H04W 60/06

(57) ABSTRACT

Systems and methods are described herein for hosting network overload and/or congestion handling (e.g., for closed access group (CAG) cells providing local services). A device (e.g., a wireless transmit/receive unit (WTRU)) may include a processor configured to perform one or more actions. The device may determine a local service identifier associated with a first closed access group (CAG) and a second CAG. The device may send a first registration request to the first CAG based on the local service identifier. The device may receive a first message (e.g. in response to the first registration request), including an indication that the registration with the first CAG is rejected, a cause code, and a back-off value. The device may send a second registration request to the second CAG based on the indication that the registration with the first CAG is rejected, the cause code, and the back-off value.

### CROSS-REFERENCE TO RELATED APPLICATIONS

This application claims the benefit of U.S. Provisional Patent Application No. 63/392,473, filed Jul. 26, 2022, the content of which is hereby incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for hosting network overload and/or congestion handling (e.g., for closed access group (CAG) cells providing local services). A device (e.g., a wireless transmit/receive unit (WTRU) may include a processor configured to perform one or more actions. The device may determine a local service identifier associated with a first closed access group (CAG) and a second CAG. The device may send a first registration request to the first CAG based on the local service identifier. The device may receive a first message (e.g., in response to the first registration request), including an indication that the registration with the first CAG is rejected, a cause code, and a back-off value. The device may send a second registration request to the second CAG based on the indication that the registration with the first CAG is rejected, the cause code, and the back-off value.

The cause code may indicate congestion.

The device may determine that the back-off value has elapsed based on a time the first message was received. The device may send a third registration request to the first CAG (e.g., after the back-off value has elapsed).

The first message may further include a redirect indication indicating the second CAG is available.

The device may receive a second message that may indicate that the WTRU is registered with the second CAG.

The first registration request may include an access Identity associated with the WTRU, and the first message may be based on the access identity. The device may receive the access identity. The access identity may indicate that the WTRU has permission to access localized services.

The first message may include a localized service ID.

A procedure may be used by a hosting network (e.g., PNI-NPN or SNPN) to implement access control. The hosting network may define an access identity for localized services. The hosting network may define access categories (e.g., for barring WTRUs accessing the hosting network via CAG Cells (PNI-NPN)).

A procedure may be used by a hosting network (e.g., PNI-NPN) to handle overload and/or congestion handling. For example, the hosting network may provide a cause code and/or back-off timer to a WTRU during initial registration of the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example network architecture for accessing local service via a Public Network Integrated Non-Public Network (PNI-NPN).

FIG. 3 illustrates an example access identity for localized services.

FIG. 4 illustrates example hosting network defined access categories.

FIG. 5 illustrates an example of overload and congestion handling for hosting networks and initial registration.

FIG. 6 illustrates an example of overload and congestion handling for hosting networks, and radio resource control (RRC) Connection Setup/Resume/Release procedures.

### DETAILED DESCRIPTION

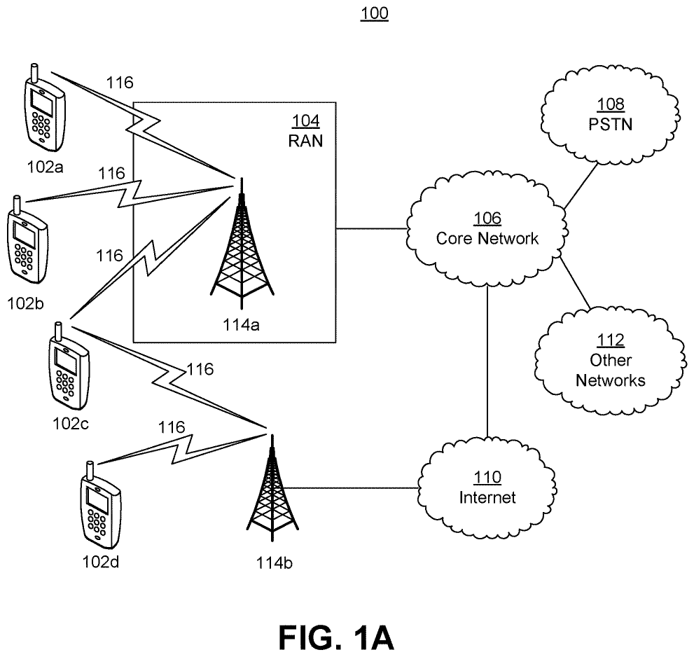

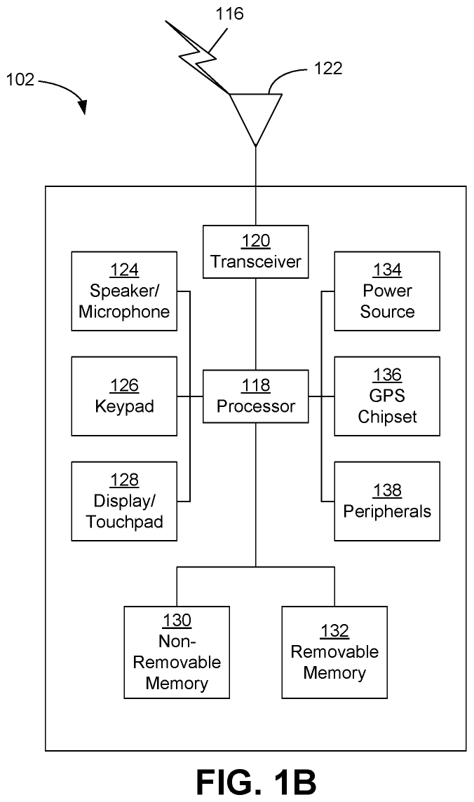

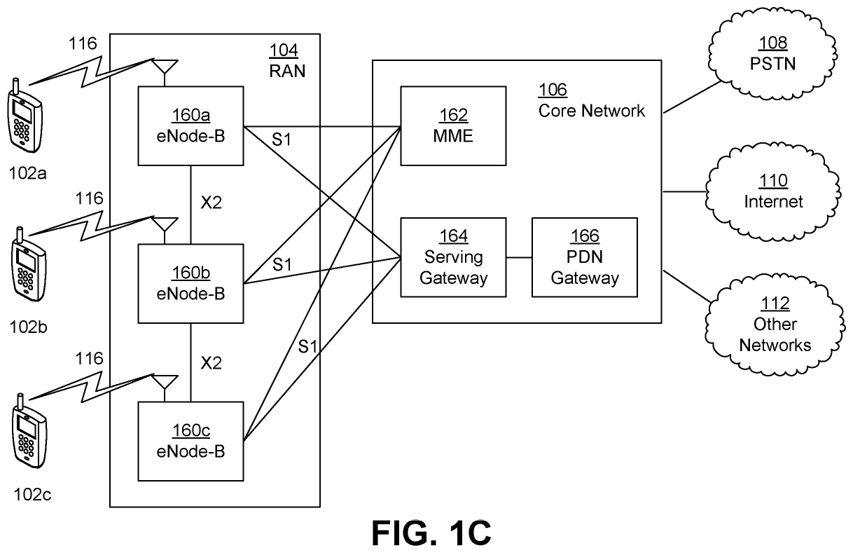

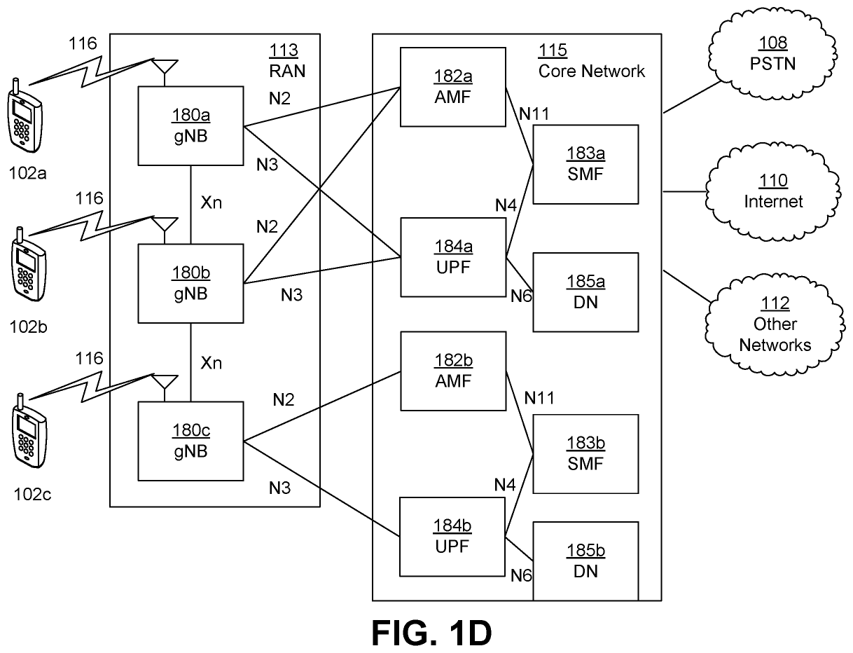

FIG. 1A is a diagram Illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-FI device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may Include High-Speed Downlink (DL) Packet Access (HSDPA) and/or High-Speed uplink (UL) Packet Access (HSUPA), In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology,

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may Include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology,

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location Information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth@ module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116, In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 1020, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off, One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 1800 in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFI.

The SMF 183a, 183b may be connected to an AMF 182a, 182b in the CN 115 via an N11 interface. The SMF 183a, 183b may also be connected to a UPF 184a, 184b in the CN 115 via an N4 Interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time (e.g., value), a time period, tracking the time, tracking the period of time, etc. Reference to a timer expiration herein may refer to determining that the time has occurred or that the period of time has expired. A timer may be based on a starting time (e.g., value), such as when a message is sent or received.

Systems and methods are described herein for hosting network access control and/or congestion handling. A cause code may be used for overload and congestion handling. A hosting network (e.g., a closed access group) may, for example upon receiving a registration request from a WTRU, send a response including a cause code. The cause code may indicate congestion. The response may reject the WTRU's registration and include a back-off timer. A back-off timer may be used to improve overload and congestion handling (e.g., by reducing the frequency of requests, such as during a period of congestion). Handling for congestion during initial registration, signaling procedures (e.g., NAS signaling procedures), connection setup/resume/release (e.g., RRC connection setup/resume/release), and/or the like may be enabled.

An access identity may be defined (e.g., by a hosting network). The access identity may be used to control access to localized services. The access identity may include access categories. For example, access identities may be used to implement access control. Access identities may bar a wireless transmit/receive unit (WTRU) from accessing hosting networks (e.g., via CAG cells).

A network may be congested (e.g., due to the number of wireless transmit/receive units (WTRUs) being connected). A WTRU may access services using a close access group (CAG) (e.g., a group of local users). Access to services via a first CAG may be congested, for example, based on the number of WTRUS that are connected. The WTRU may switch to a different CAG to access the service (e.g., during a period of congestion on the first CAG), for example, to improve access control and congestion handling. Overload and congestion handling for CAG cells providing local services may be enabled.

For example, a WTRU may determine that a service is provided by a first CAG and a second CAG. The WTRU may send a registration request to the first CAG. The WTRU may receive a first indication indicating that the registration (e.g., to the first CAG) is rejected, for example, based on congestion. The WTRU may (e.g., based on the received indication) send a second registration request to the second CAG. The WTRU may receive a second indication that indicates that the registration (e.g., to the second CAG) was successful.

In examples, the first indication that indicates that the registration to the first CAG was rejected may indicate a back-off time (e.g., value). The back-off time may be a duration of time for the WTRU to wait before sending another registration request (e.g., where the back of time may be specific to the first CAG where the registration has been rejected). The back-off time may be specific (e.g., unique) to the WTRU (e.g., different for other WTRUs), for example, to prevent simultaneous registration requests. The WTRU may determine that the back-off time has elapsed. The WTRU may (e.g., based on the determination that the back-off time has elapsed) send another registration request to the first CAG, Providing access to local services (PALS) may be enabled.

Systems and methods are described herein for hosting network overload and/or congestion handling (e.g., for closed access group (CAG) cells providing local services). A device (e.g., a wireless transmit/receive unit (WTRU)) may include a processor configured to perform one or more actions. The device may determine a local service identifier associated with a first closed access group (CAG) and a second CAG. The device may send a first registration request to the first CAG based on the local service identifier. The device may receive a first message (e.g., in response to the first registration request), including an indication that the registration with the first CAG is rejected, a cause code, and a back-off value. The device may send a second registration request to the second CAG based on the indication that the registration with the first CAG is rejected, the cause code, and the back-off value.

The cause code may indicate congestion.

The device may determine that the back-off value has elapsed, based on the time the first message was received. The device may send a third registration request to the first CAG (e.g., after the back-off value has elapsed).

The first message may further include a redirect indication indicating the second CAG is available.

The device may receive a second message that may indicate that the WTRU is registered with the second CAG.

The first registration request may include an access identity associated with the WTRU, and the first message may be based on the access identity. The device may receive the access identity. The access identity may indicate that the WTRU has permission to access localized services.

The first message may include a localized service ID.

A procedure may be used by a hosting network (e.g., public network integrated NPN (PNI-NPN) or SNPN) to implement access control. The hosting network may define an access identity for localized services. The hosting network may define access categories, for example, for barring WTRUs from accessing the hosting network via CAG Cells (PNI-NPN).

A procedure may be used by a hosting network (e.g., PNI-NPN) to handle overload and/or congestion handling. For example, the hosting network may provide a cause code and/or back-off timer to a WTRU during the initial registration of the WTRU.

Local services may include services that are available in a (e.g., limited) area and/or time duration. For example, a local network (e.g., temporary local network) may be set up in a sports event or a fairground where a cellular network is not available. A local network through which local services are provided may be referred to as a hosting network. A hosting network may (e.g., usually) not be permanent (e.g., may be short-term implementation without permanent infrastructure). A hosting network may be a permanent network. A hosting network may be a Standalone Non-Public Network (SNPN), or a Public Network Integrated Non-Public Network (PNI-NPN), or a public land mobile network (PLMN). The local service provider may be the hosting network operator or a 3rd party service provider.

APNI-NPN may be provided and/or enabled. A PNI-NPN may be a non-public network made available using PLMN infrastructure/resources. e.n. a PI MN network slice. A group of PLMN users (e.g., which may be allowed to access a certain PNI-NPN) may be referred to as a close access group (CAG). A CAG may be identified by a CAG identifier. CAG users may (e.g., only) access a PNI-NPN, for example, from a cell that supports CAG access, which may be referred to as a CAG cell. A CAG cell may broadcast a list of supported CAG identifiers (e.g., that it supports). A CAG WTRU may be configured by the network with a list of CAGs it may access (e.g., an allowed CAG list). If (e.g., when) a CAG WTRU detects a CAG cell, the CAG WTRU may (e.g., only) select/access the CAG cell, for example, if at least one of the broadcasted CAG identifiers matches one of the CAG identifiers in its allowed CAG list.

Unified access control may be provided and/or enabled. A WTRU may establish a radio connection with the radio access network (NG-RAN), for example, for the WTRU to transmit a message (e.g., an initial NAS message). The NAS layer may provide (e.g., RRC) connection establishment related information to the lower layers and this information may be used by the RAN to determine the priority of the connection and whether the connection may be established (e.g., either access may be allowed or blocked). The network may protect itself against overload (e.g., under high network load conditions), for example, by using the unified access control functionality to limit access attempts from WTRUs. The network may determine whether an access attempt (e.g., a certain access attempt) may be allowed or blocked based on categorized criteria, for example, depending on network configuration. The NG-RAN may broadcast barring control information associated with access categories and access identities.

A WTRU may perform access control checks to determine if access is allowed, for example, if (e.g., when) the WTRU is trying to (e.g., needs to) access the network (e.g., 5GS). Access control checks may be performed for access attempts. The NAS layer in the WTRU may map the access attempt to one or more access identities and an (e.g., one) access category. The access category (e.g., each access category) may be selected from the set of standardized access categories and/or operator defined access categories. The NAS layer may provide the access identities and access category to the lower layers. The lower layers may perform access barring checks based on the determined access identities and access category (e.g., comparing it with the broadcast information from the NG-RAN). The NAS may initiate the procedure to send the initial NAS message for the access attempt, for example, if the lower layers indicate that the access attempt is allowed.

NAS level congestion control may be provided and/or enabled. NAS level congestion control may be applied in general (e.g., for all NAS messages), per data network name (DNN), per Single-Network Slice Selection Assistance Information (S-NSSAI), per DNN and S-NSSAI, and/or for a specific group of WTRUS.

NAS level congestion control may be achieved by providing the WTRU (e.g., each rejected WTRU) with a back-off time. To avoid large amounts of WTRUs initiating deferred requests (e.g., almost) simultaneously, the core network, which may be a 5GC, may determine or select a back-off time for the WTRU (e.g., each WTRU). The back-off time may be determined or selected such that the back-off time is unique for a WTRU (e.g., each WTRU, so that the deferred requests may not be synchronized). The back-off timer may be determined or selected to minimize the number of WTRUs applying at any time. If (e.g., when) the WTRU receives a back-off time, the WTRU may refrain from initiating (e.g., not initiate) a (e.g., any) signaling (e.g., NAS signaling) with regard to the applied congestion control. The WTRU may initiate signaling in one or more of the following conditions: the back-off timer expires; the WTRU receives a mobile terminated request from the network; the WTRU initiates signaling for emergency services or high priority access; or the WTRU enters a (e.g., new) PLMN which may be not part of the equivalent PLMN list.

An access and mobility function (AMF) may reject NAS message(s) from WTRU(s) using an (e.g., any) access network (AN), such as a 5G-AN, under general overload conditions. The AN may indicate a cause code, such as cause code #22 that may indicate congestion. A mobility management back-off time may be sent by the AMF to the WTRU, for example, if (e.g., when) a NAS request is rejected. The WTRU may refrain from initiating (e.g., not initiate) a (e.g., any) NAS request (e.g., except for a deregistration procedure and/or procedures not subject to congestion control, for example, such as, high priority access, emergency services and mobile terminated services), for example, if (e.g., while) the mobility management back-off time is being tracked (e.g., a back-off timer is running).

Multiple local services may be hosted (e.g., simultaneously). For example, multiple local services may be hosted when the hosting network is standalone non-public network (SNPN). The CAG cells may support access to local services and/or normal services (e.g., when the hosting network is PNI-NPN).

There may be many WTRUs in the coverage of the hosting network (e.g., a SNPN cell or a CAG cell). The number of WTRUs may cause congestion in the hosting network. The network operator (e.g., either an SNPN operator or a PLMN operator) may prioritize service user(s) (e.g., prioritize certain service user(s) when congestion occurs in the hosting network). For example, in a SNPN hosting network, the network operator may prioritize the access of local service A, while limiting the access of local service B. For example, in a PNI-NPN hosting network, the PLMN operator may prioritize access of normal services and may limit access of local services.

The hosting network may control the access of various services to mitigate overload and congestion. The hosting network (PNI-NPN or SNPN) may implement access control. The hosting network (PNI-NPN) may handle congestion. For example, the hosting network may send a cause code to indicate reason(s) for rejecting a WTRU and/or a back-off time to reduce the frequency of access requests (e.g., repeat access requests from the WTRU).

A network architecture may be provided and/or used for the networks used herein.

For example, for overload and congestion handling, a cause code may be used. A back-off timer may be used, for example, to improve overload and congestion handling. Handling for congestion during initial registration, signaling procedures (e.g., NAS signaling procedures), and connection setup/resume/release (e.g., RRC connection setup/resume/release) may be enabled.

A defined access identity for localized services and hosting network defined access categories may be provided, for example, for carrying out access control and barring wireless transmit/receive units (WTRUs) from accessing hosting networks (e.g., via CAG Cells).

A network may be congested, for example, based on the number of wireless transmit/receive units (WTRUs) that are connected. A WTRU may access services using a close access group (e.g., a group of local users). Access to services via a first close access group (CAG) may be congested, for example, based on the number of WTRUs that are connected. The WTRU may switch to a different CAG to access the service, for example, to improve access control and congestion handling. Overload and congestion handling for CAG cells providing local services may be enabled.

For example, a WTRU may determine that a service is provided by a first CAG and a second CAG. The WTRU may send a registration request to the first CAG. The WTRU may receive a first indication that indicates that the registration (e.g., to the first CAG) is rejected, for example, based on congestion. The WTRU may (e.g., based on the received indication) send a second registration request to the second CAG. The WTRU may receive a second indication that indicates that the registration (e.g., to the second CAG) was successful.

In examples, the first indication that indicates that the registration to the first CAG was rejected may indicate a back-off time. The back-off time may be a duration of time for the WTRU to wait before sending another registration request (e.g., where the back off time may be specific to the first CAG where the registration has been rejected). The back-off time may be specific to the WTRU (e.g., different for other WTRUs), for example, to prevent simultaneous registration requests. The WTRU may determine that the back-off time has elapsed. The WTRU may (e.g., based on the determination that the back-off time has elapsed) send another registration request to the first CAG.

Local services may be provided, for example, via a PNI-NPN or SNPN.

For example, a SNPN may host multiple local services (e.g., at the same time).

For example, a PNI-NPN may include one or more CAG cells (e.g., inside a PLMN). The local services may be provided by the PLMN operator itself or a third party service provider (e.g., which has a service agreement with the PLMN operator). Potential local service users may include PLMN subscribers (e.g., including roaming users). The user(s) may or may not have a subscription with the PLMN operator for accessing local services.

The CAG cells (e.g., that support local services) may be dedicated. For example, the WTRUs may (e.g., only) access local services from the CAG cells. The CAG cells may be non-dedicated. For example, the WTRUs may access the local services and other PLMN services from the CAG cells.

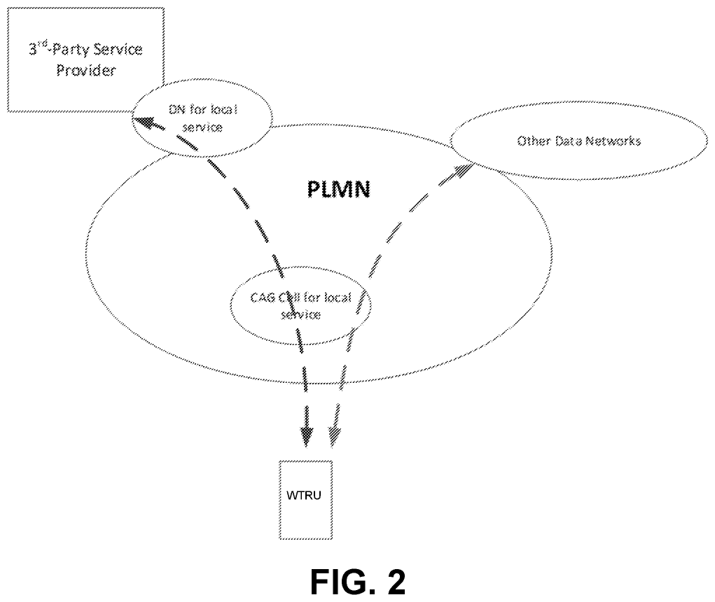

FIG. 2 illustrates an example network architecture for accessing local service via PNI-NPN. Unified access control optimization for a WTRU accessing a local service hosting network may be provided and/or enabled. Access control optimization for the hosting networks may Include providing local services via SNPN or PNI-NPN/CAG cells. An access identity (e.g., specific access identity) may be used for accessing local services. The access identity (e.g., specific access identity) may be (pre)configured within the WTRU (e.g., via Universal Subscriber Identity Module (USIM) or may be configured via signaling (e.g., NAS signaling).

A UISM elementary file, such as EF_UAC_AIC, may be enhanced (e.g., to include access identity value(s) specific to localized services usage).

Signaling (e.g., NAS signaling) may be used (e.g., by the AMF, hosting network, or 3rd party service provider) to push an access identity validity to a WTRU (e.g., a determination of whether an access identity is valid/invalid). Signaling (e.g., NAS signaling) to push an access identity validity may be implemented via a network feature supporting information element (IE) or new IE, for example within a message (e.g., registration accept NAS message). Signaling (e.g., NAS signaling) to push an access identity validity may be implemented via a priority indicator IE or new IE, for example as part of a message (e.g., a configuration update NAS message).

The access identity associated with (e.g., specific to) accessing local services provided by a hosting network may allow for the hosting network to perform one or more of the following: differentiating (e.g., high) priority subscription WTRUs (e.g., those which have been assigned with the access identity) against normal subscribers (e.g., priority access for premium subscription customers/WTRUs); differentiating inbound roamers from home subscribers accessing localized services; prioritizing access for non-dedicated CAG cells based on the network priority; prioritizing access for (e.g., certain) local services based on network priority (e.g., If multiple local services are supported in the network); or cell load balancing and congestion control (e.g., under high load conditions, access control and barring may be used to redirect WTRUs to different cells for accessing local services).

An access identity may be used for accessing local services and may enable a hosting network to prioritize access for non-dedicated CAG cells based on network priority. For example, if a WTRU may be trying to access localized services (e.g., via non-dedicated CAG cells), it may be given preference over WTRUs that are accessing the same CAG cell for normal services or vice-versa.

In a roaming environment, the WTRU may consider the access identity associated with (e.g., specific for) localized services to be valid (e.g., if the access identity is provided by the current PLMN, such as a visitor PLMN after registration/NAS signaling and/or the value stored in the USIM is refrained from being considered (e.g., may not be considered) for roaming scenarios).

A hosting network may provide hosting network defined access categories to the WTRU, for example, via (e.g., NAS) signaling (e.g., Registration/Mobility/Configuration Update Command, SoR, UE/WTRU parameter update procedures etc.). The hosting network defined access categories may be similar to operator defined access categories (e.g., with the difference that these access categories may be (e.g., only) applicable to access attempts for localized services).

The hosting network access category criteria may include one or more of the following: localized service type (e.g., Identifier); time validity; and location validity.

The access category criteria may be used by the WTRU (e.g., while choosing the access category for an access attempt for accessing localized services).

Under high network load conditions, a hosting network may protect itself using the (e.g., existing) unified access control mechanism with the (e.g., new) updates (e.g., access identity (e.g., new access identity) and access categories defined (e.g., specifically) for accessing localized services).

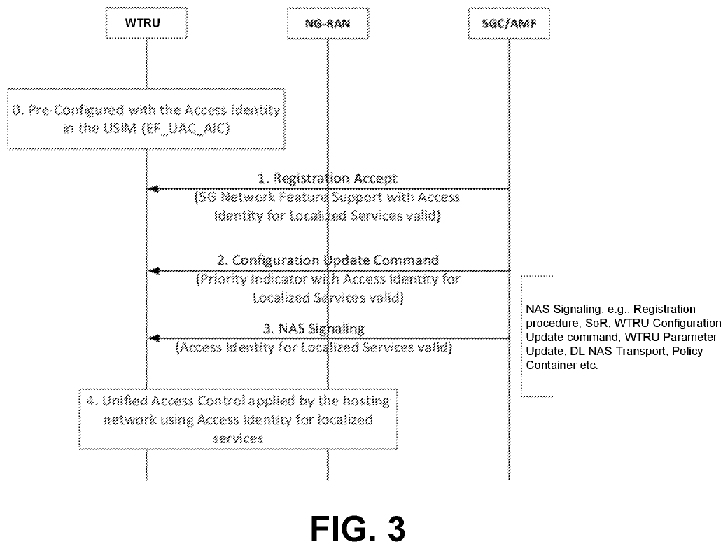

FIG. 3 illustrates an example access identity for localized services.

As shown in FIG. 3 at 0, the WTRU may be pre-configured with the access identity for localized services (e.g., in the USIM EF_UAC_AIC). The WTRU may use an access identity for localized services for (e.g., all) access attempts with respect to localized services (e.g., while registered to either HPLMN or Equivalent HPLMN). The access identify may be used in a (e.g., any) PLMN. For example (e.g., in a visitor PLMN scenario), the WTRU may monitor for a validity flag from the network (e.g., if it is available).

As shown in FIG. 3 at 1, IE network feature support may (e.g., optionally) be extended to include access identity for localized services that are valid (e.g., Boolean flag True/False). For example, access identity may be sent by a core network (e.g., 5GC). The access identity may be sent via a message (e.g., signaled, such as including the access identity in a REGISTRATION ACCEPT NAS message). An access identity for localized services validity bit may indicate that the access identity for localized services is valid and may be used by the WTRU for accessing localized services (e.g., in a visitor PLMN or in HPLMN/Equivalent HPLMN use case), for example, If access identity for localized services is not configured in the USIM,

As shown in FIG. 3 at 2, an IE priority indicator (e.g., a preexisting IE Priority Indicator) may be extended to include access identity for localized services that are valid (e.g., Boolean flag True/False). The extended IE priority indicator may be sent by a core network (e.g., 5GC), The extended IE priority indicator may be signaled (e.g., included in a WTRU CONFIGURATION UPDATE COMMAND NAS message). An access Identity for localized services validity bit may indicate that access identity for localized services is valid and may be used by the WTRU for accessing localized services (e.g., in a visitor PLMN or in HPLMN/Equivalent HPLMN use case), for example, if access identity for localized services is not configured in the USIM.

As shown in FIG. 3 at 3, an IE (e.g., a new IE) may be defined to carry an access identity for a localized service valid flag via (e.g., NAS) signaling (e.g., Registration procedure, SoR, WTRU Configuration Update command, WTRU Parameter Update, DL NAS Transport, Policy Container, etc.). An access identity for a localized services validity bit may indicate that the access identity for localized services (e.g., included in the IE) is valid and may be used by the WTRU for accessing localized services (e.g., in a visitor PLMN or in HPLMN/Equivalent HPLMN use case), for example, if access identity for localized services is not configured in the USIM.

As shown in FIG. 3 at 4, based on the type of service (e.g., if the type of service is a normal or localized service), the WTRUs (e.g., WTRUs' NAS layer) may determine or select the access identity and applicable access category. The access identity and/or applicable access category may be determined or selected from the hosting network defined access categories (e.g., if the request is for a local service) and/or standard access category (e.g., if the request is for normal service). The WTRU may provide the determined or selected access identity and/or applicable access category to the AS layer to carry out the access barring. The WTRU (e.g., AS layer) may determine the access barring information that is applicable based on the broadcasted access barring information (e.g., via the cell). The WTRU (e.g., AS layer) may use the information provided by the NAS layer to perform an access barring check. The NAS layer may go ahead with its procedure (e.g., registration) with the (e.g., 5G) core network, for example, if the access barring is successful and radio access is allowed (e.g., by the NG-RAN).

Localized services may have validity (e.g., based on time and location). The core network, such as a 5GC, may use (e.g., NAS signaling) messages to enable/disable access identity for a localized services valid flag. Enabling and/or disabling access identity for the localized services valid flag may ensure access attempts that occur outside a time window or a location where localized services are not present are blocked (e.g., by the NG-RAN using unified access control).

In a home environment (e.g., WTRU registered with HPLMN or Equivalent HPLMN (EHPLMN)), an access identity for localized services value configured in the USIM may take precedence over the validity flag provided by the network (e.g., via NAS Signaling). If the network would like to disable/enable or remove/add the access identity for localized services from the USIM, the network may trigger a SIM Refresh procedure, for example, to update the contents of USIM EF_UAC_AIC removing/adding access identity for localized services.

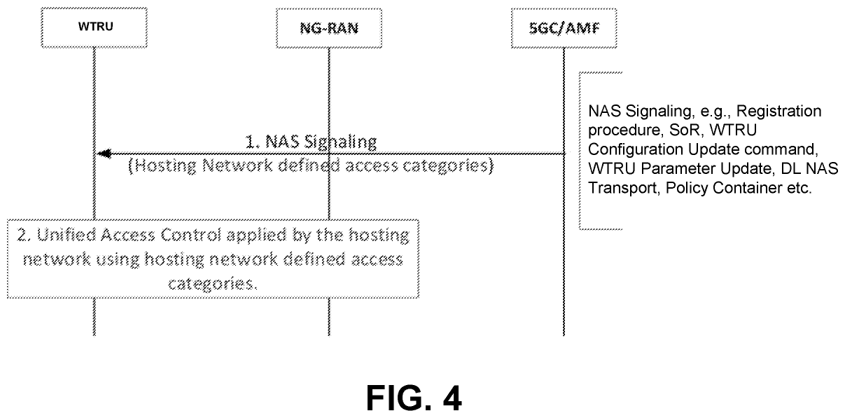

FIG. 4 illustrates example hosting network defined access categories.

As shown in FIG. 4 at 1, hosting network defined access categories may be signaled, for example, by the core network (e.g., 5GC), Access categories may be signaled via NAS signaling (e.g., Registration procedure, SoR, WTRU Configuration Update command, WTRU Parameter Update, DL NAS Transport, Policy Container etc.).

Hosting network defined access category criteria may include additional information (e.g., in addition to (e.g., existing) operator defined access categories, such as DNN/Slice/OS Id/App Id). Hosting network defined access category criteria may include one or more of the following: a localized service type identifier (e.g., Access Category applicable for specific localized service, which may enable creating service differentiation at the hosting network side); or validity criteria based on time and/or location (e.g., which may ensure access attempts for localized services are (e.g., only) allowed within an area and in a particular time window).

As shown in FIG. 4 at 2, based on the type of service (e.g., if the type of service is normal or localized service), the WTRUs (e.g., WTRUs' NAS layer) may determine the access identity and applicable access category out of the hosting network defined access categories (e.g., If the request is for a local service) or standard access category (e.g., if the request is for normal service). The WTRU (e.g., WTRUs' NAS layer) may provide this information (e.g., to the AS layer) to carry out the access barring. The WTRU (e.g., AS layer) may determine the access barring information that is applicable (e.g., as per the broadcasted access barring information via the cell) and use the information provided by the NAS layer to carry out the access barring check. The NAS layer may proceed with its procedure (e.g., registration) with the core network (e.g., 5G), for example, if access barring is successful and radio access may be allowed (e.g., by the NG-RAN).

In examples, the hosting network may apply service-specific access barring in its cells. For example, the CAG cells that support both local services and normal services may broadcast access barring Information for local services and normal services respectively (e.g., two sets of access barring information). The WTRU (e.g., NAS layer in the WTRU) may determine whether the WTRU is accessing the cell for local service(s) or normal service(s). The WTRU may indicate whether the WTRU is accessing the cell for local service(s) or normal service(s) (e.g., to the AS layer). The WTRU (e.g., AS layer) may determine which set of access barring information may be applied. For example, the cells (e.g., either a SNPN cell or a CAG cell) that support multiple local services may broadcast multiple sets of access barring Information (e.g., with each set of barring information associated with one or more services). The WTRU (e.g., NAS layer in the WTRU) may indicate the desired service identifier (e.g., to the AS layer). The WTRU (e.g., AS layer) may determine the set of access barring information that is associated with the requested service (e.g., access identity and applicable hosting network defined access category based on selected service identifier by NAS layer/user/application layer).

The hosting network may prioritize access for certain services and block access for other services to alleviate congestion in the network (e.g., by adjusting the information in various sets of access barring info). This method may be used in combination with assigning (e.g., new) access identity or access categories for local service users (e.g., as described herein).

Congestion control for hosting networks (e.g., PNI-NPN) may be enabled. A hosting network may support measures to guard itself from conditions where network functions are overloaded (e.g., peak operating times, extreme overload, a number (e.g., a large number) of WTRUs requesting access to local service, diminished performance etc.). For example, a hosting network may deploy measure(s) to control congestion and overload to ensure that network functions (e.g., for the hosting network) are operating under nominal capacity for providing necessary localized services to the WTRU.

A hosting network (e.g., 5GC) may implement (e.g., NAS level) congestion control. For example, the hosting network may implement general NAS level congestion control where an AMF may reject the NAS requests from a WTRU with a cause code (e.g., cause code #22, which may indicate congestion), and the rejection AMF may provide the back-off time (e.g., via a back-off timer, such as, for example, T3346). The back-off time may (e.g., temporarily) restrict the WTRU to make any further NAS requests (e.g., except for the deregistration procedure and procedures not subject to congestion control, such as, for example, high priority access, emergency services, and mobile terminated services).

In examples, the hosting network may be a PNI-NPN (e.g., CAG cells). If CAG cells (e.g., particular CAG cells) are overloaded, the network may determine to redirect the WTRUs to other CAG cells which are not overloaded (e.g., other CAG cells that would not reject the WTRUs with generic NAS level congestion cause #22 message). Redirection of WTRUs may not restrict (e.g., any new) NAS requests from the WTRU for the complete hosting network and its equivalent hosting networks (ePLMNs) (e.g., as may occur with a NAS level congestion cause #22 message). If the WTRU is restricted from camping (e.g., not allowed to camp) on other CAG cells it may be restricted from triggering NAS requests (Registration Procedure).

The hosting network may handle overload conditions for a CAG cell (e.g., a CAG cell) by redirecting the WTRUs to different CAG cells that provide access to localized service, and/or backing off the WTRUs from overloaded or congested CAG cells (e.g., by signalling a back-off time).

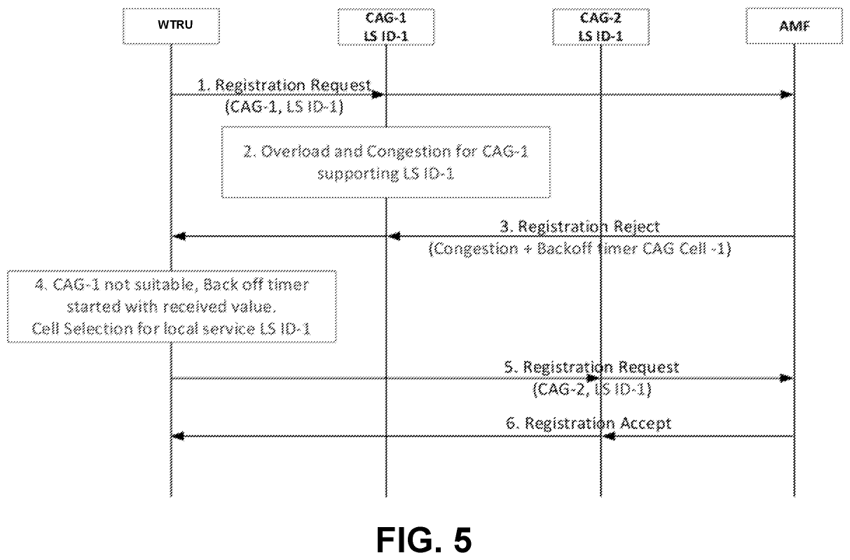

FIG. 5 illustrates an example of overload and congestion handling for hosting networks, and for initial registration.

As shown in FIG. 5 at 1, the WTRU may perform cell selection for CAG cells. For example, it may do so according to the requested local service (e.g., local service identifier-1). The WTRU may find CAG cells CAG-1 and CAG-2 providing the requested local service. The WTRU may perform an initial registration with the CAG-1. A registration request may be sent to the AMF via CAG-1, for example, including the requested local service identified via LS ID-1.

As shown in FIG. 5 at 2, the CAG-1 may be under overload and congestion. Other CAG cells (e.g., CAG-2) may be in the vicinity and may provide access to local services identified via LS ID-1.

As shown in FIG. 5 at 3, the AMF of the hosting network may reject the initial registration request with a cause code congestion (e.g., a new cause code) and may provide a back-off time value (e.g., tracked via a back-off timer). This reject cause may be applicable to the (e.g., current) camped CAG cell (e.g., CAG-1). The AMF may select the back-off time value so that deferred registration requests (e.g., from different WTRUs) are not synchronized, for example, to avoid an amount (e.g., a large amount) of WTRUS initiating a deferred registration request at or near the same time (e.g., simultaneously).

As shown in FIG. 5 at 4, CAG-1 may be unsuitable for accessing the local service. The WTRU may start tracking a back-off time (e.g., via a back-of timer) per CAG-1. While the back-off time is tracked, the WTRU may refrain from initiating (e.g., NAS) requests (e.g., no NAS requests may be initiated by the WTRU) for the CAG-1 cell. The WTRU may trigger cell selection for accessing local services LS ID-1.

CAG-2 may be a possible candidate cell, and the WTRU may camp and trigger initial registration on the CAG-2.

As shown In FIG. 5 at 5, a registration request for local service LS ID-1 may be sent to the hosting network via CAG-2.

As shown in FIG. 5 at 6, registration may be accepted by the hosting network. The WTRU may be successfully registered for local services.

In examples, overload and congestion handling specified for initial registration may be extended to other NAS procedures (e.g., Mobility Registration Update procedure, Service Request procedure, etc.). A hosting network may trigger de-registration toward the WTRU to overcome overload and congestion, and may provide the WTRU with back-off time value per CAG cell.

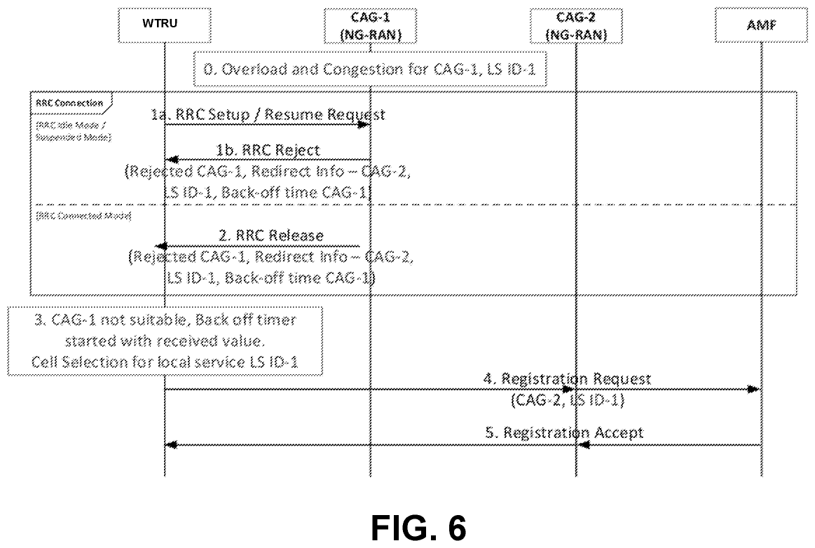

FIG. 6 illustrates an example of overload and congestion handling for hosting networks (e.g., RRC Connection Setup/Resume/Release).

As shown in FIG. 6 at 0, the CAG-1 may be under overload and congestion. Other CAG cells (e.g., CAG-2) may be in the vicinity, which may provide access to local services identified via LS ID-1.

As shown in FIG. 6 at 1a/1b, the WTRU may (e.g., attempt to) set up the initial RRC connection with the NG-RAN/CAG-1, or the RRC connection is suspended, and the WTRU may (e.g., attempt to) resume the RRC connection. As CAG-1 may be under overload, NG-RAN may reject the RRC connection set up or resumption with RRC reject and provide Rejected CAG list (CAG-1), RRC Redirect information with available CAG cells nearby, along with local service support identifier and back-of time value for CAG-1.

As shown in FIG. 6 at 2, (e.g., alternatively) the WTRU may be in RRC connected mode and (e.g., to handle the overload/congestion) the hosting network may decide to release the RRC connection (e.g., via an RRC Release message) and provide Rejected CAG list (CAG-1), RRC redirect information with available CAG cells nearby, along with a local service support identifier and back-off time value for CAG-1.

As shown in FIG. 6 at 3, the CAG-1 may be unsuitable for accessing the local service. The WTRU may start tracking a back-off time (e.g., via a back-off timer) per CAG-1. While the back-off time is being tracked, the WTRU may refrain from initiating NAS requests (e.g., no NAS requests would be initiated by the WTRU) for the CAG-1 cell. The WTRU may trigger cell selection for accessing local services LS ID-1. CAG-2 may be a possible candidate cell as per the provided RRC Redirect information, and the WTRU may camp and trigger initial registration on the CAG-2.

As shown in FIG. 6 at 4, the registration request for local service LS ID-1 may be sent to the hosting network, for example, via CAG-2.

As shown in FIG. 6 at 5, the registration may be accepted by the hosting network. The WTRU may be successfully registered for local services.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A wireless transmit/receive unit (WTRU) comprising:
a processor configured to:
send a first registration request to a first network node, wherein the first network node is associated with a first hosting network that is configured to provide access to a localized service;
receive a first registration response, wherein the first registration response indicates that the first registration request was rejected, indicates a cause code, and indicates to perform a cell reselection procedure;
on a condition of receiving the indication of the cause code, determine a second network node, wherein the second network node is associated with a second hosting network that is configured to provide access to the localized service; and
send a second registration request to the second network node.

20. The WTRU of claim 19, wherein the cause code indicates congestion.

21. The WTRU of claim 19, wherein the first hosting network that is configured to provide access to the localized service is associated with a first closed access group (CAG), and wherein the second hosting network that is configured to provide access to the localized service is associated with a second CAG.

22. The WTRU of claim 19, wherein the indication to perform the cell reselection procedure comprises information associated with the second network node.

23. The WTRU of claim 19, wherein the first hosting network is a Standalone Non-Public Network (SNPN) or a Public Network Integrated Non-Public Network (PNI-NPN).

24. The WTRU of claim 19, wherein the first registration response does not indicate a back-off timer value.

25. The WTRU of claim 6, wherein the cause code does not indicate congestion.

26. A method comprising:
sending a first registration request to a first network node, wherein the first network node is associated with a first hosting network that is configured to provide access to a localized service;
receiving a first registration response, wherein the first registration response indicates that the first registration request was rejected, indicates a cause code, and indicates to perform a cell reselection procedure;
on a condition of receiving the indication of the cause code, determining a second network node, wherein the second network node is associated with a second hosting network that is configured to provide access to the localized service; and
sending a second registration request to the second network node.

27. The method of claim 26, wherein the cause code indicates congestion.

28. The method of claim 26, wherein the first hosting network that is configured to provide access to the localized service is associated with a first closed access group (CAG), and wherein the second hosting network that is configured to provide access to the localized service is associated with a second CAG.

29. The method of claim 26, wherein the indication to perform the cell reselection procedure comprises information associated with the second network node.

30. The method of claim 26, wherein the first hosting network is a Standalone Non-Public Network (SNPN) or a Public Network Integrated Non-Public Network (PNI-NPN).

31. The method of claim 26, wherein the first registration response does not indicate a back-off timer value.

32. The method of claim 31, wherein the back-off timer value is associated with restricting a WTRU from requesting access to the first network node.

33. The method of claim 31, wherein the cause code does not indicate congestion.

34. A network node, the network node comprising:
a processor configured to:
receive a registration request message from a wireless transmit/receive unit (WTRU), wherein the registration request message indicates a request for access to a localized service via a hosting network associated with the network node;
on a condition that the registration request message is received when congestion control is active, generate a registration response that refrains from assigning a back-off timer value to the WTRU, wherein the registration response indicates that the registration request message was rejected, indicates to perform a cell reselection procedure, and indicates a cause code associated with the congestion control; and
send the registration response to the WTRU.

35. The network node of claim 34, wherein the cause code associated with the congestion control indicates congestion.

36. The network node of claim 34, wherein the back-off timer value is associated with restricting the WTRU from requesting access to the network node, and wherein the cause code does not indicate congestion.

37. The network node of claim 34, wherein the indication to perform the cell reselection procedure comprises information associated with a second network node.

38. The network node of claim 34, wherein the hosting network is a Standalone Non-Public Network (SNPN) or a Public Network Integrated Non-Public Network (PNI-NPN), and wherein the hosting network is associated with a closed access group (CAG).
